(19) United States
(12) Patent Application Publication
(10) Pub. No.: US 2024/0386147 A1
(43) Pub. Date: Nov. 21, 2024

(54) DEVICE AUTHENTICATION FOR BUS COMMUNICATION

(71) Applicant: Verzon Patent and Licensing Inc., Basking Ridge, NJ (US)

(72) Inventors: John M Stokes, Yorba Linda, CA (US); Emilia C. Quijano, East Brunswick, NJ (US); Manuel E. Caceres, Basking Ridge, NJ (US)

(21) Appl. No.: 18/198,916

(22) Filed: May 18, 2023

(51) Int. Cl. G06F 21/85; G06F 21/60

(52) U.S. Cl. CPC G06F 21/85; G06F 21/602

(57) ABSTRACT

One or more computing devices, systems, and/or methods for device authentication for bus communication are provided. Connection of a device to a bus of a host device is detected. Accordingly, a driver is loaded by the host device for communicating with the device over the bus. A bus authentication operation is performed by the host device to determine whether to allow or block the device from further communicating over the bus. The host device (e.g., the driver, an operating system, etc.) attempts to verify authentication information associated with the device. If the authentication information is successfully verified, then the device is allowed to continue communicating over the bus. Otherwise, the device is blocked from communicating over the bus.

### BACKGROUND

Many devices utilize physical buses for communication. A host device may include a universal serial bus connected to a universal serial bus port. Another device, such as a storage device, a laptop, a phone, a dongle, or a portable device, may connect to the universal serial bus port in order to communicate with the host device over the universal serial bus. For security purposes, some host devices are configured to lock out or block certain types of devices. For example, a corporate laptop may be configured to block storage devices that attempt to connect to the corporate laptop through a port connected to a bus of the corporate laptop so that a malicious entity does not transfer sensitive corporate documents from the corporate laptop to a storage device. In another example, devices of a network can wirelessly connect to a router for communicating over the network. For security reasons, the router may disable physical ports of the router so that devices cannot physically connect to the router.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram illustrating an example of a system for device authentication for bus communication, in accordance with an embodiment of the techniques presented herein;

FIG. 2 is a flow chart illustrating an example method for device authentication for bus communication, in accordance with an embodiment of the techniques presented herein;

FIG. 3A is a diagram illustrating an example of a system for device authentication for bus communication, in accordance with an embodiment of the techniques presented herein;

FIG. 3B is a diagram illustrating an example of a system for device authentication for bus communication, where a device is authenticated, in accordance with an embodiment of the techniques presented herein;

FIG. 3C is a diagram illustrating an example of a system for device authentication for bus communication, where a device fails authentication, in accordance with an embodiment of the techniques presented herein;

FIG. 4 is a diagram illustrating an example of a system for device authentication for bus communication, where authentication information is obtained from remote source(s), in accordance with an embodiment of the techniques presented herein;

FIG. 5 is a diagram illustrating an example of a system for device authentication for bus communication, in accordance with an embodiment of the techniques presented herein;

FIG. 6 is a flow chart illustrating an example method for device authentication for bus communication, in accordance with an embodiment of the techniques presented herein;

FIG. 7 is an illustration of example networks that may utilize and/or implement at least a portion of the techniques presented herein;

FIG. 8 is an illustration of a scenario involving an example configuration of a computer that may utilize and/or implement at least a portion of the techniques presented herein;

FIG. 9 is an illustration of a scenario involving an example configuration of a client that may utilize and/or implement at least a portion of the techniques presented herein;

FIG. 10 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of computing scenarios in which the disclosed subject matter may be utilized and/or implemented.

One or more systems and/or techniques for device authentication for bus communication are provided. Many computing systems implement access control for security purposes. Within an Internet of Things (IoT) computing network (or any other type of network), host devices may implement a security policy where universal serial bus ports of the host devices are disabled so that other devices cannot connect to the host devices. Disabling the universal serial bus ports improves security of the host devices and the IoT computing network because another device cannot connect to a host device in order to steal information or inject code for performing malicious activities. For example, a malicious user may connect a storage device to a host device through a universal serial bus port of the host device in order to download sensitive information from the host device to the storage device.

Some security mechanisms may be capable of selectively disabling certain types of devices that are attempting to connect to the host device. For example, the universal serial bus port may be disabled if the device is a storage device. However, these security mechanisms do not provide adequate selective and granular communication bus security that could otherwise enable access that would improve the operation of a host device such as where a laptop would be allowed to connect to the host device in order to perform troubleshooting, install updates, install new functionality, etc. There is a lack of access control for physical ports and communication buses because access control is assumed based upon physical proximity of the device being physically connected to the host device. In contrast, much more detailed and complex access control is provided when devices are connecting over a network to a host device, such as when a web browser is connecting to a banking website.

In order to improve security of the host device while allowing certain devices to communicate with the host device such as for troubleshooting, techniques are provided herein for device authentication for bus communication. Instead of merely allowing or blocking a device based upon a device type of the device, the techniques provided herein are capable of authenticating devices based upon authentication information (e.g., private keys, public keys, symmetric keys, etc.) and authentication mechanisms (e.g., a certification authority and/or chain certificates). In this way, an authenticated device is allowed to communicate over a communication bus of the host device (e.g., communicate through a physical port over a physical bus of the host device), and a device that fails to authenticate is blocked from communicating over the communication bus. This provides a more granular level of security while still allowing certain devices to connect in order to execute functionality for improving the operation of the host device (e.g., perform an update, perform troubleshooting, installing new functionality, etc.).

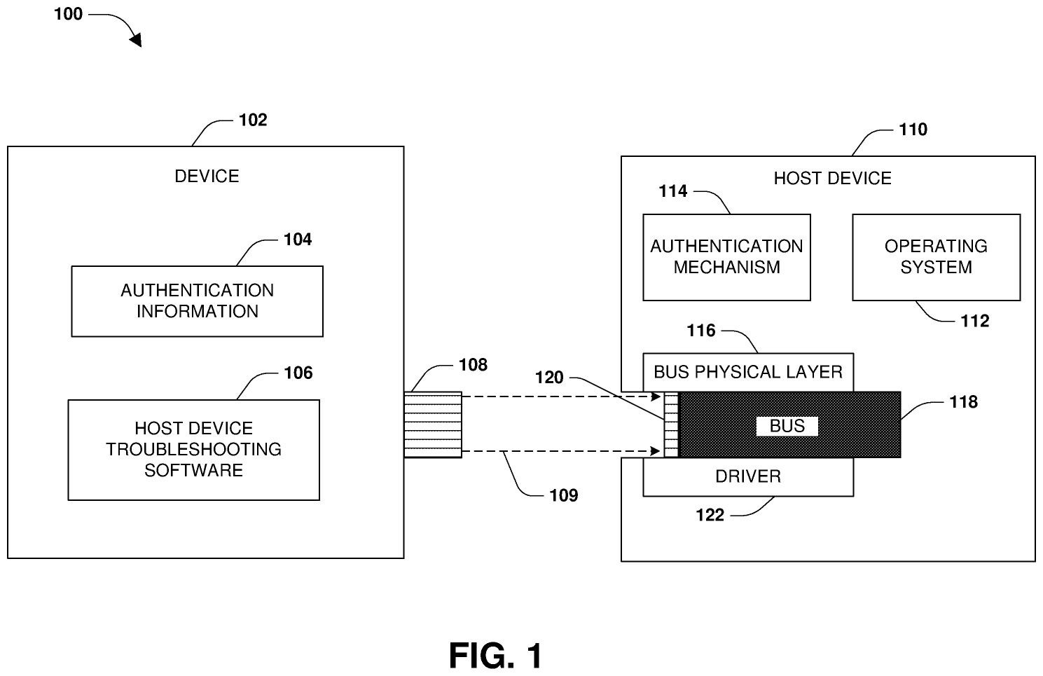

FIG. 1 is a diagram illustrating an example of a system 100 for device authentication for bus communication. A host device 110 comprises a port 120 (e.g., a physical hardware port). The port 120 is communicatively coupled to a bus 118 of the host device 110. The bus 118 may be communicatively coupled to other components of the host device 110, such as memory, a storage device, a network adapter, a processor, etc. As illustrated by FIG. 1, the port 120 is located such that an external device can connect to the port 120. In other embodiments not illustrated by FIG. 1, the port 120 is located internal to the host device 110 such that a device installed internally within the host device 110 (e.g., flash memory inserted into a storage device port, a system on chip, etc.) can connect to the bus 118. In some embodiments, the bus 118 is a universal serial bus (USB), a universal asynchronous receiver transmitter (UART) bus, or any other type of data, address, or control bus.

The host device 110 includes a bus physical layer 116 that is configured to establish communication over the bus 118 for devices that are connected to the port 120. The bus physical layer 116 performs a handshake sequence with a device that connects to the port 120. The handshake sequence includes various steps such as a speed test, identifying the type of device (e.g., a hardware category of a device such as a storage device, a laptop, headphones, a smart watch, a human interface device such as a mouse or keyboard, etc.), other categorization type tests, selecting and loading a driver 122 that corresponds to that type of device, and enabling or blocking communication based upon the type of device (e.g., storage devices may be categorically blocked). The host device 110 may include an operating system 112 that controls operation of the host device 110 (e.g., orchestrates the execution of programs, the route of I/O to a processor, the storing data within memory or storage, etc.).

As provided herein, the host device 110 utilizes an authentication mechanism 114 in order to determine whether to allow or block a device from communicating through the port 120 over the bus 118. In some embodiments, the host device 110 hosts the authentication mechanism 114, as illustrated by FIG. 1. In some embodiments, a remote device hosts the authentication mechanism 114 that the host device 110 can remotely invoke over a network connection to the remote device (e.g., a trusted third party authentication service). It may be appreciated that a variety of different authentication mechanisms may be utilized as the authentication mechanism 114, such as certificates issued by a certificate authority (e.g., chain certificates, root certificates, secure sockets layer (SSL) certificates, transport layer security (TLS) certificates, etc.). A certificate issued by a certificate authority may be a digital certificate used to authenticate the identity of a device connected to the port 120, along with enabling an encrypted connection over the bus 118. The certificate may be issued to a device to verify that a trusted third party has authenticated the device's identity. The certificate may be a small data file that cryptographically establishes an encryption link between the device and the host device 110.

Such certificates have been conventionally utilized for establishing secure communication links between web servers and browsers over an Internet connection where the browsers are hosted by devices (e.g., a cellular phone, a laptop, etc.) that are not physically connected to the web servers, but could be located hundreds of miles from one another. The techniques provided herein utilizes these certificates in a non-routine and non-conventional manner in order to determine whether to allow a port 120 (a physical hardware port) to stay enabled/active so a device physically connected to the port 120 can communicate over the bus 118 through the port 120 or whether to disable the port 120, disconnect the device, and/or block the device from communicating through the port 120 and over the bus 118. This improves the security of the port 120 and bus 118 of the host device 110 such that the host device 110 can selectively enable or disable the port 120 based upon whether a device can successfully authenticate through the authentication mechanism 114.

In some embodiments, a device 102 may physically connect 109 to the port 120 (a universal serial bus port) using a universal serial bus connector 108. The device 102 may comprise an IoT device, a laptop, a mobile device, a storage device, flash memory, a device that can be installed within the host device 110, a system on chip (SoC), or any other electronic device that has a connector that can connect to the port 120 or is capable of physically connecting to the bus 118 through another connection means (e.g., an internal physical connection to the bus 118 when the device is installed within the host device 110 such as where a memory card is inserted into the host device 110).

When the device 102 physically connects 109 to the port 120 using the universal serial bus connector 108, the host device 110 obtains authentication information 104 (e.g., a key or certificate, which may be issued by a certificate authority) associated with the device 102. In some embodiments, the authentication information 104 may be stored by the device 102 and is transmitted through the port 120 and bus 118 to the host device 110 for authentication using the authentication mechanism 114, as illustrated by FIG. 1. In other embodiments, the authentication information 104 is retrieved by the host device 110 from a remote source such as a block chain ledger or remote server, which may be identified using information provided by the device 102 to the host device 110 or using information preloaded into the host device 110.

If the authentication mechanism 114 successfully authenticates the device 102, then the device 102 is allowed to communicate through the port 120 and over the bus 118. The authentication mechanism 114 may be implemented by the driver 122 or the operating system 112, which may instruct the bus physical layer 116 to leave the port 120 enabled for the device 102 to communicate over the bus 118. In this way, the device 102 may install firmware, install programming code, send or receive data, perform troubleshooting of the host device 110 using host device troubleshooting software 106, etc. If the authentication mechanism 114 does not successfully authenticate the device 102, then the device 102 is disconnected and/or blocked from communicating through the port 120 over the bus 118. In some embodiments, the bus physical layer 116 may be instructed to disable the port 120 so that the device 102 cannot communicate through the port 120.

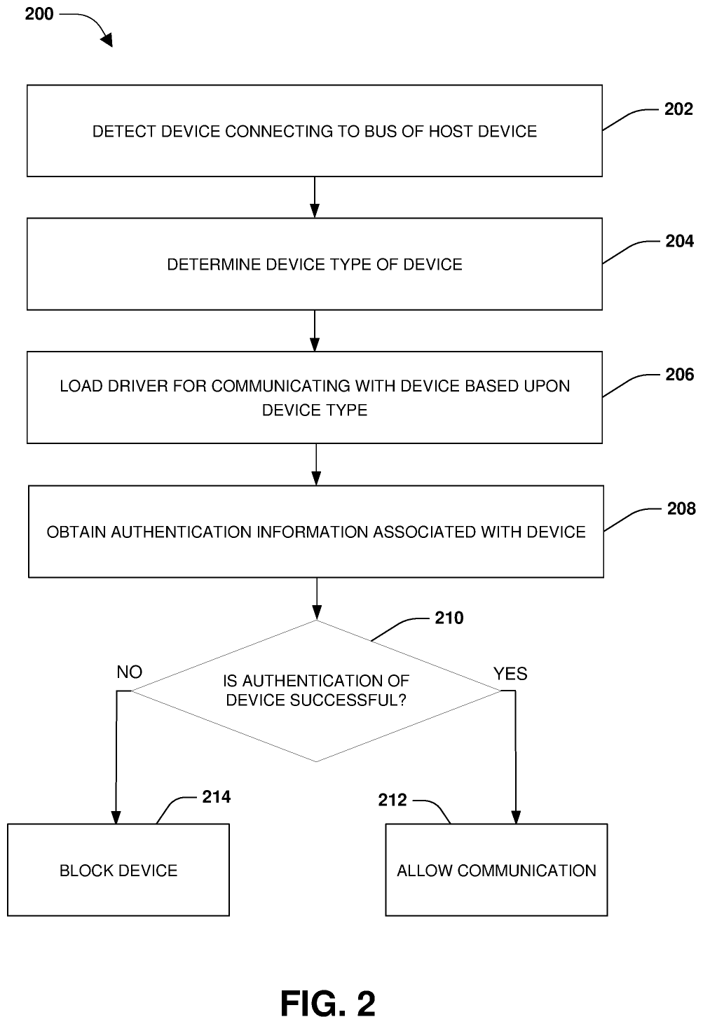

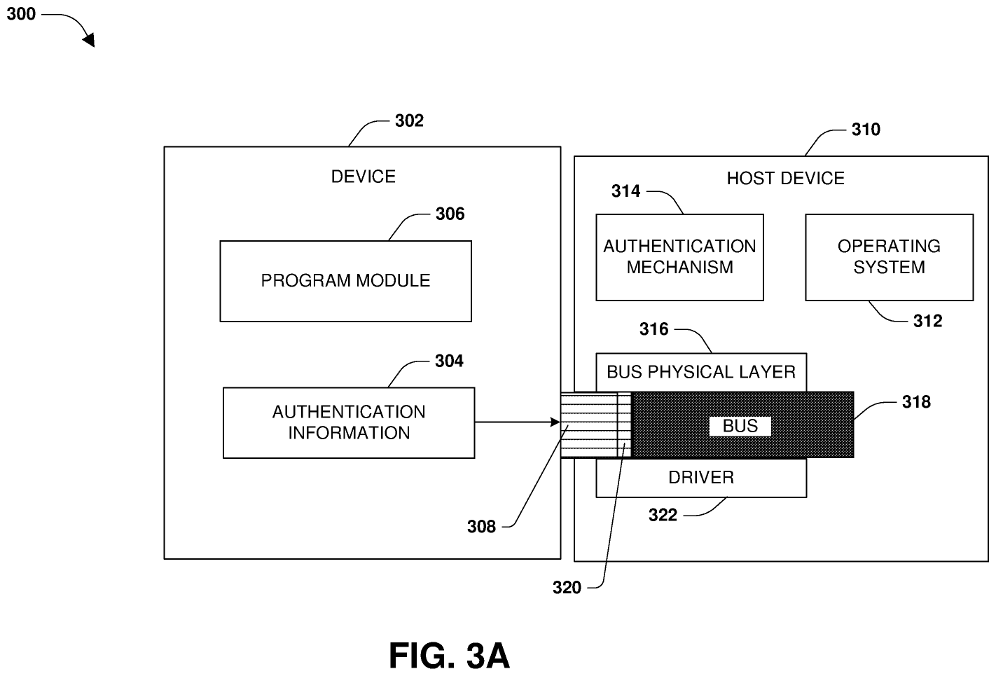

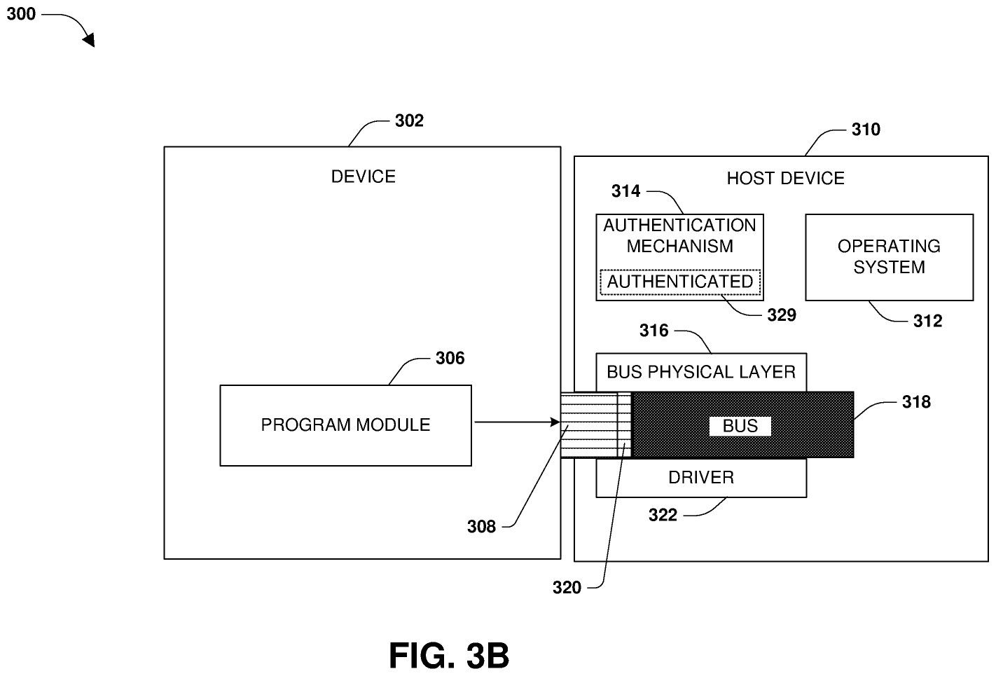

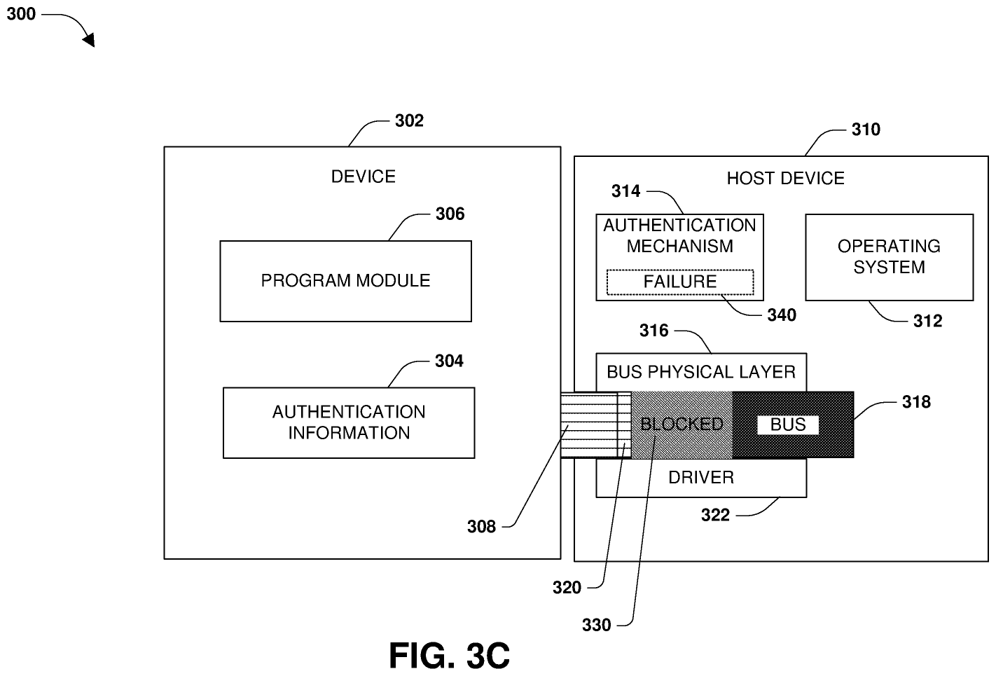

FIG. 2 is a flow chart illustrating an example method 200 for device authentication for bus communication, which is further described in relation to system 300 of FIGS. 3A-3C. A device 302 may connect to a host device 310 by physically connecting a port connector 308 of the device 302 to a port 320 connected to a bus 318 of the host device 310, as illustrated by FIG. 3A. The device 302 may comprise a storage device, a laptop, a mobile device, an IoT device, flash memory, a system on chip (SoC), or any other type of device. The host device 310 may comprise a router (e.g., a CRSP router), a computing device, network equipment, cellular equipment, an IoT device, a system on chip (SoC), or any other type of electronic device that has a port and/or a bus over which devices can communicate. The bus 318 may be an internal bus within the host device 310, a universal serial bus, a bus that utilizes a universal asynchronous receiver transmitting (UART) protocol, or any other type of communication bus.

During operation 202 of method 200, a bus physical layer 316 of the host device 310 detects the connection of the port connector 308 of the device 302 to the port 320 of the host device 310. In response to detecting the connection of the device 302 to the host device 310 through the port 320, the bus physical layer 316 implements a handshake sequence that performs various speed tests, hardware tests, etc. As part of the handshake sequence, the bus physical layer 316 may determine a device type of the device 302, during operation 204 of method 200. The device type may be a storage device, a laptop, a human machine interface device such as a mouse or keyboard, etc. During operation 206 of method 200, the bus physical layer 316 selects a driver 322 from a set of available drivers based upon the driver 322 corresponding to the device type of the device 302. The bus physical layer 316 loads the driver 322 that enables communication with the device 302 over the bus 318 and through the port 320. In this way, the bus physical layer 316 establishes a communication channel with the device 302 over the bus 318. In some embodiments, the loading of the driver 322 triggers a bus authentication operation that uses an authentication mechanism 314 (e.g., a universal serial bus authentication for a universal serial bus) to authenticate the device 302.

In some embodiments, the bus authentication operation may be performed by the driver 322 using the authentication mechanism 314. In some embodiments, the bus authentication operation may be performed by an operating system 312 of the host device 310 using the authentication mechanism 314. In some embodiments, the bus authentication operation may be performed by a remote device or service accessed by the host device 310 over a network connection (e.g., a 3^{rd} party trusted authentication service). In some embodiments, the bus authentication operation may be implemented through security controls executing over the bus physical layer 316 (e.g., security controls executed above the bus physical layer 316 within a stack of the host device 310). In some embodiments, the bus authentication operation utilizes a public key infrastructure (PKI) as part of the authentication mechanism 314 for authenticating a key associated with the device 302 (e.g., a key received as authentication information 304 from the device 302 through the port 320 or a public key retrieved from a remote source over a network). In some embodiments, the bus authentication operation utilizes transport layer security (TLS) as part of the authentication mechanism 314 for authenticating a TLS certificate associated with the device 302 (e.g., a certificate received as the authentication information 304 from the device 302 through the port 320 or a certificate retrieved from a remote source over a network).

In some embodiments of implementing the bus authentication operation, the device 302 is considered to be and/or operates similar to an untrusted server while the host device is considered to be and/or operates similar to a trusted client, which is the opposite of how client devices (web browsers) and remote web servers are considered when establishing a connection over a network where the remote web servers are treated as untrusted servers and the client devices are treated as trusted clients.

During operation 208 of method 200, the host device 310 obtains the authentication information 304 associated with the device 302. In some embodiments, the authentication information 304 comprises a key (e.g., a private key, a public key, a symmetric key, etc.) generated from a certificate authority associated with the authentication mechanism 314. In some embodiments, the key is received through the port 320 and over the bus 318 from the device 302. In some embodiments, the key is retrieved from a remote source over a network by the host device 310. In some embodiments, the key is retrieved from a distributed ledger (e.g., a block chain) stored across a plurality of remote data sources. In this way, the authentication mechanism 314 is used to authenticate/validate/verify the authentication information 304 such as the key or other information.

During operation 210 of method 200, a determination is made as to whether the authentication mechanism 314 successfully authenticated the authentication information 304. In some embodiments, the key is authenticated using a certificate authority hosted by the host device 310 or elsewhere (e.g., a trusted third party). The certificate authority may have been used to create the key. The key may be authenticated using a root certificate and one or more chain certificates (e.g., certificates issued by the trusted third party).

In response to successfully authenticating 329 the authentication information 304 using the authentication mechanism 314, the port 320 is maintained in an enabled state and the device 302 is allowed to communicate through the port 320 over the bus 318 with the host device 310, during operation 212 of the method 200. The device 302 may execute a program module 306 in order to interact with the host device 310 such as to retrieve data from the host device 310 over the bus 318, send data to the host device 310 over the bus 318, troubleshoot the host device 310, install a program, perform a system, software, or firmware upgrade on the host device 310, etc., as illustrated by FIG. 3B.

In response to the authentication mechanism 314 not successfully 340 authenticating the authentication information 304 as illustrated by FIG. 3C, the device 302 is blocked 330 from communicating with the host device 310 over the bus 318, during operation 214 of method 200. In some embodiments, the port 320 is disabled in order to block 330 the device 302 from communicating with the host device 310. In some embodiments, the device 302 is unmounted from the host device 310.

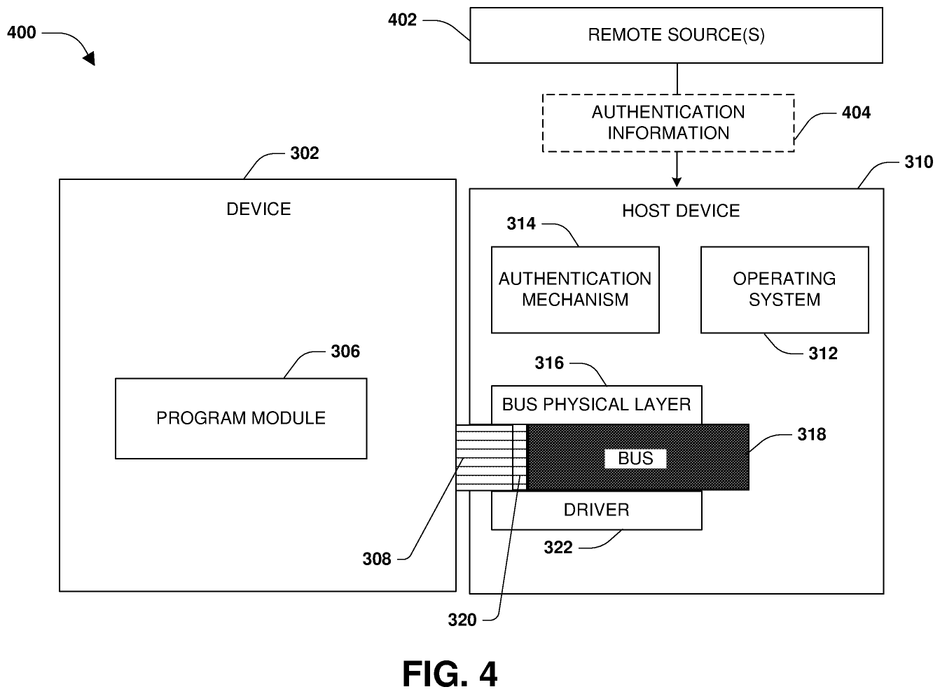

FIG. 4 is a diagram illustrating an example of a system 400 for device authentication for bus communication, where authentication information 404 is obtained from remote source(s). The device 302 may connect to the host device 310 such that the port connector 308 is connected to the port 320. During authentication of the device 302, the host device 310 may determine that the device 302 is not storing the authentication information 404 that is to be used for authenticating the device 302. In some embodiments, the device 302 may transmit an indication to the host device 310 of where to locate the authentication information 404 (e.g., an indication describing a website, service, distributed ledger, trusted third party, etc.). In some embodiments, locational information of where to obtain the authentication information 404 may be maintained by the host device 310 and is not provided by the device 302. In this way, the authentication information 404 is retrieved from the remote source(s) 402 for authenticating the device 302.

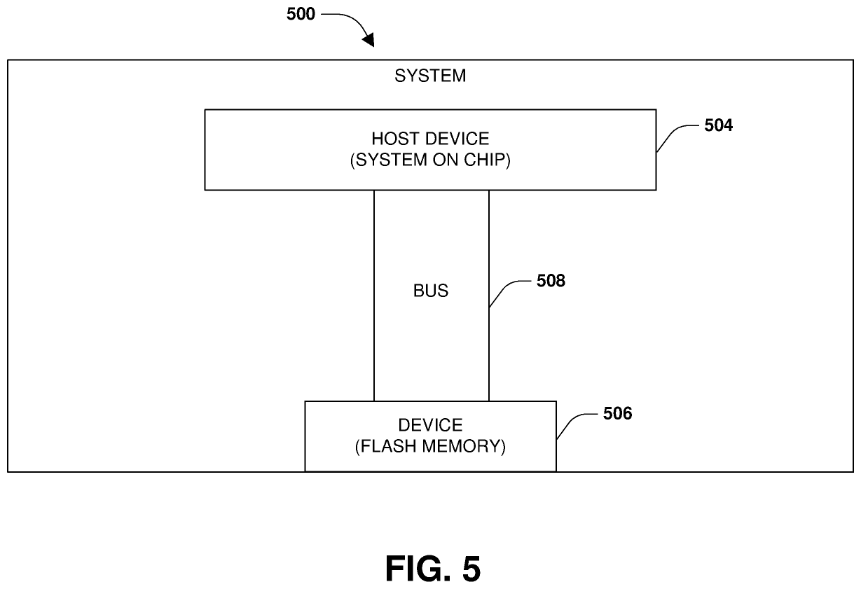

FIG. 5 is a diagram illustrating an example of a system 500 for device authentication for bus communication. The system 500 (e.g., a smart device, an IoT device, a router, network equipment, cellular equipment, or any other electronic device) comprises a bus 508. The bus 508 may be an internal communication bus over which components and devices within the system 500 can communicate. The system 500 may comprise a host device 504, such as a system on chip (e.g., an audio receiver, an analog-to-digital converter, a microprocessor, memory, input/output logic control, or other self-contained computing system with a central processing unit, memory, storage, I/O ports, etc.). The host device 504 may be connected to the bus 508 through a port.

A device 506 may be connected to or installed within the system 500 (e.g., a flash memory card may be inserted into the system 500). The device 506 may be connected to the bus 508 through a port. The techniques that have been described herein may be used by the host device 504 to either allow or block the device 506 from communicating over the bus 508 based upon whether authentication information associated with the device 506 is successfully authenticated or not.

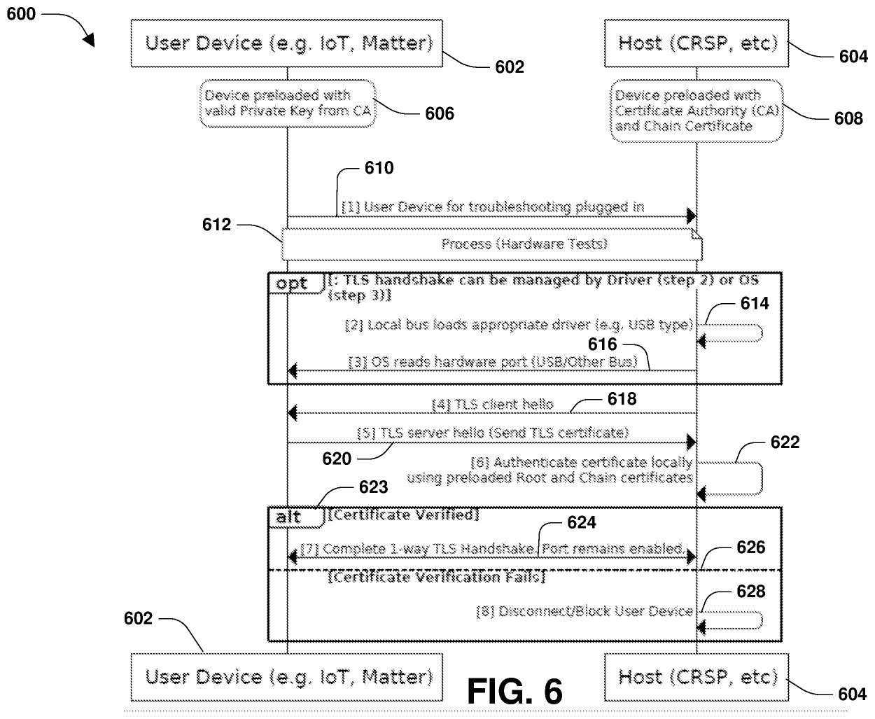

FIG. 6 is a flow chart illustrating an example method for device authentication for bus communication. A user device 602 may be preloaded 606 with a key issued by a certificate authority to the user device 602 (e.g., a private key, a public key, a symmetric key, etc.). A host device 604 may be preloaded 608 with certificate authority and/or chain certificates (e.g., a private key, a public key, a symmetric key, etc.). The host device 604 detects 610 the user device 602 plugging into a port of a local bus of the host device 604 (e.g., a hardware port of a physical bus). The host device 604 performs 612 hardware tests and/or other tests, such as a speed test, a test to detect the device type of the user device 602, etc. Based upon the device type, the local bus loads 614 a corresponding driver (e.g., a universal serial bus driver based upon the user device 602 plugging into a universal serial bus port of the host device 604). An operating system of the host device 604 reads 616 the port of the local bus. The host device 604 transmits 618 a TLS client hello message to the user device 602 over the local bus. The host device 604 receives 620 a TLS server hello message with a TLS certificate from the user device 602. The host device 604 authenticates 622 the TLS certificate using root and chain certificates.

If the TLS certificate is verified 623 by the host device 604, then a 1-way TLS handshake is completed 624 and the port remains enabled so that the user device 602 can communicate through the port over the local bus with the host device 604. If the TLS certificate fails 626 to be verified by the host device 604, then the user device 602 is disconnected and/or blocked 628.

According to some embodiments, a method may be provided. The method includes detecting a device attempting to connect to a universal serial bus port of a host device; performing a test to determine a device type of the device; loading, by the host device, a driver for communicating with the device based upon the driver corresponding to the device type; and performing, by the driver, a universal serial bus authentication by: obtaining a key associated with the device; attempting to authenticate the key using an authentication mechanism; in response to successfully authenticating the key, retaining the universal serial bus port in an enabled state for allowing the device to communicate through the universal serial bus port with the host device; and in response to not successfully authenticating the key, blocking the device from communication through the universal serial bus port with the host device.

According to some embodiments, the method includes receiving the key from the device through the universal serial bus port.

According to some embodiments, the method includes retrieving the key from a remote source over a network.

According to some embodiments, the method includes retrieving the key from a distributed ledger stored across a plurality of remote data sources.

According to some embodiments, the method includes attempting to authenticate the key using a certificate authority hosted by the host device, wherein the key is derived from the certificate authority.

According to some embodiments, the method includes key using a chain certificate hosted by the host device.

According to some embodiments, the universal serial bus authentication considers the device to be an untrusted server and the host device to be a trusted client.

According to some embodiments, the method includes in response to loading the driver, triggering the universal serial bus authentication.

According to some embodiments, the method includes implementing the universal serial bus authentication through security controls executing over a universal serial bus physical layer.

According to some embodiments, the method includes in response to retaining the universal serial bus port in the enabled state, facilitating a troubleshooting procedure with the device in order to troubleshoot the host device.

According to some embodiments, a host device is provided. The host device comprises a processor for executing instructions for performing a bus authentication operation associated with authenticating devices for communication with the host device. The host device comprises a bus physical layer that establishes communication channels over a bus with devices connected to the bus. The host device comprises a driver that is loaded for communicating to a device that is connected to the bus, wherein the driver is selected from available drivers based upon the driver corresponding to a device type of the device. The host device comprises an operating system that performs the bus authentication operation by: obtaining authentication information associated with the device; attempting to authenticate the authentication information using an authentication mechanism; in response to successfully authenticating the authentication information, allowing the device to communicate over the bus with the host device; and in response to not successfully authenticating the authentication information, blocking the device from communication over the bus with the host device.

According to some embodiments, the operating system utilizes a key infrastructure as the authentication mechanism, and wherein the authentication information comprises a key.

According to some embodiments, the operating system utilizes transport layer security (TLS) as the authentication mechanism to determine whether a TLS certificate within the authentication information is valid.

According to some embodiments, the bus is associated with a universal asynchronous receiver transmitter (UART) protocol.

According to some embodiments, at least one of the host device or the device comprises an Internet of Things (IoT) device.

According to some embodiments, the bus is an internal bus within the host device.

According to some embodiments, at least one of the device or the host device comprises flash memory, and wherein at least one of the device or the host device comprises a system on chip (SoC).

According to some embodiments, a non-transitory computer-readable medium storing instructions that when executed facilitate performance of operations, is provided. The operations include detecting a device attempting to connect to a universal serial bus port of a host device; loading, by the host device, a driver for communicating with the device based upon the driver corresponding to a device type of the device; and performing a universal serial bus authentication by: obtaining authentication information associated with the device; attempting to authenticate the authentication information using an authentication mechanism; in response to successfully authenticating the authentication information, allowing the device to communicate over the bus with the host device; and in response to not successfully authenticating the authentication information, blocking the device from communication over the bus with the host device.

According to some embodiments, the universal serial bus authentication is performed by an operating system of the host device.

According to some embodiments, the universal serial bus authentication is performed by the driver.

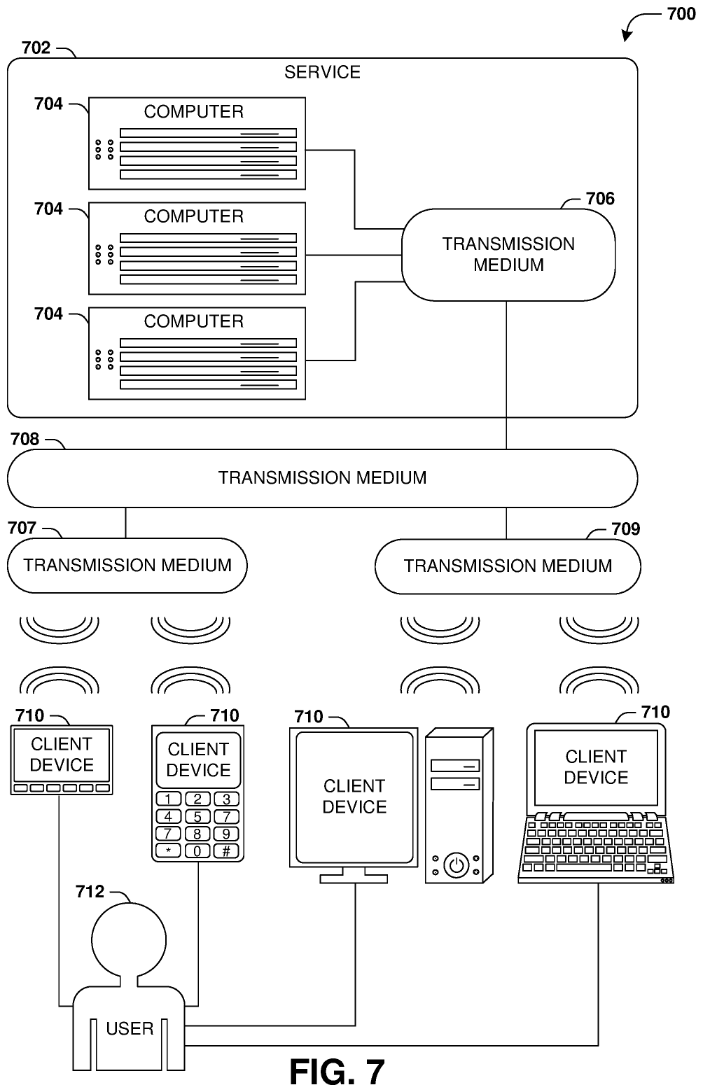

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 707 provided by a cellular provider. As a second such example, one or more client devices 710 may communicate with the service 702 by connecting to the transmission medium 708 via a transmission medium 709 provided by a location such as the user's home or workplace (e.g., a WiFi (Institute of Electrical and Electronics Engineers (IEEE) Standard 702.11) network or a Bluetooth (IEEE Standard 702.15.1) personal area network). In this manner, the computers 704 and the client devices 710 may communicate over various types of transmission mediums.

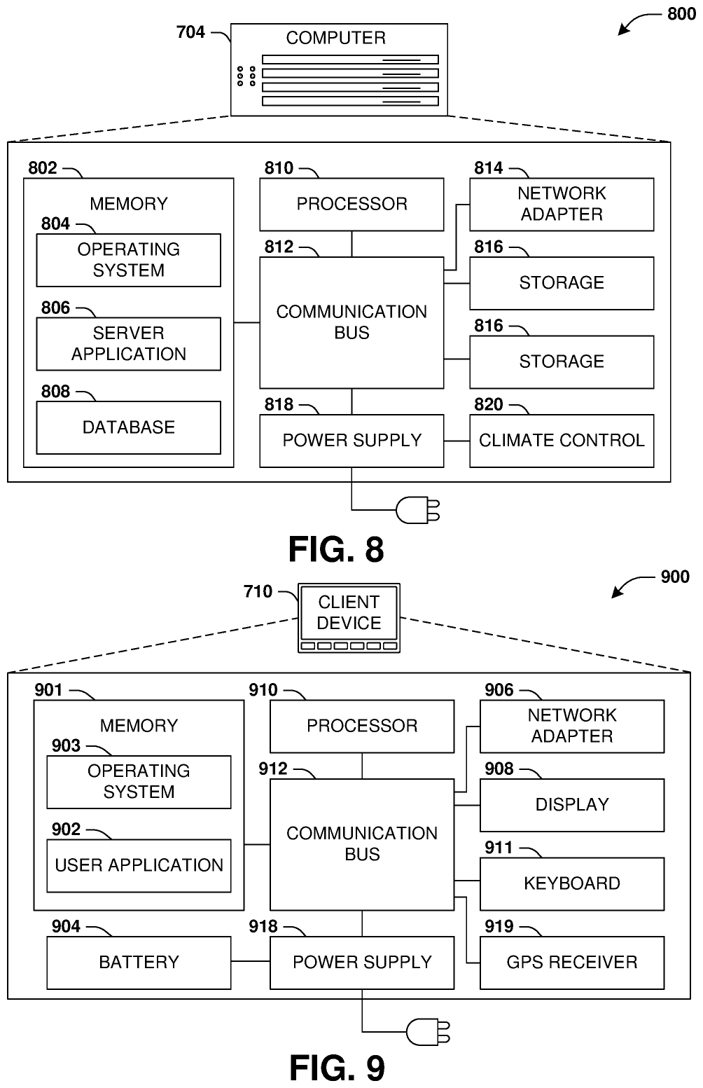

FIG. 8 presents a schematic architecture diagram 800 of a computer 704 that may utilize at least a portion of the techniques provided herein. Such a computer 704 may vary widely in configuration or capabilities, alone or in conjunction with other computers, in order to provide a service such as the service 702.

The computer 704 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 704 may comprise memory 802 storing various forms of applications, such as an operating system 804; one or more computer applications 806; and/or various forms of data, such as a database 808 or a file system. The computer 704 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 704 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 704 with at least one other computer. Other components that may optionally be included with the computer 704 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 704 to a state of readiness.

The computer 704 may operate in various physical enclosures, such as a desktop or tower, and/or may be integrated with a display as an “all-in-one” device. The computer 704 may be mounted horizontally and/or in a cabinet or rack, and/or may simply comprise an interconnected set of components. The computer 704 may comprise a dedicated and/or shared power supply 818 that supplies and/or regulates power for the other components. The computer 704 may provide power to and/or receive power from another computer and/or other devices. The computer 704 may comprise a shared and/or dedicated climate control unit 820 that regulates climate properties, such as temperature, humidity, and/or airflow. Many such computers 704 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

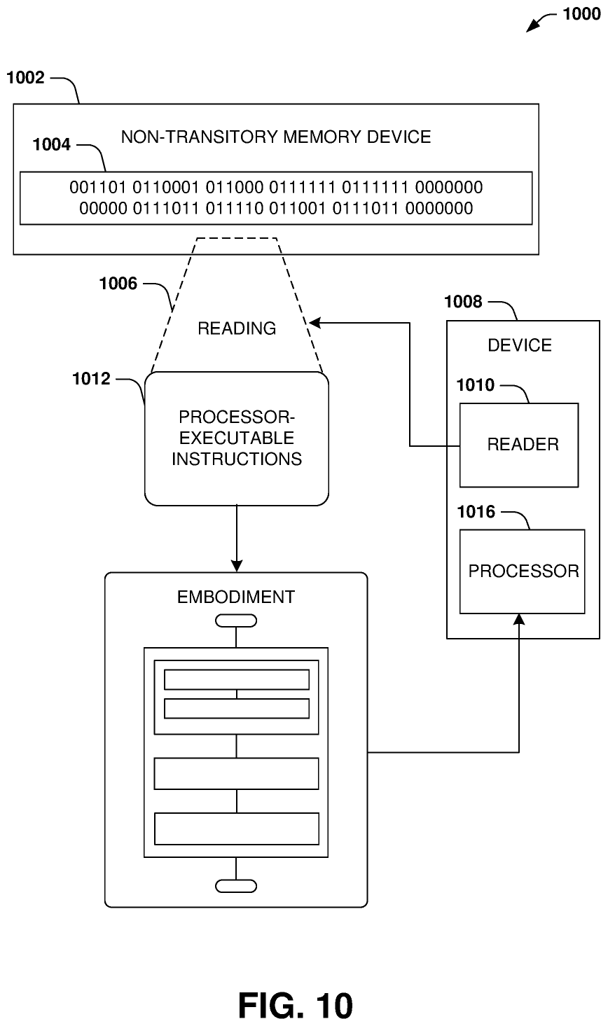

FIG. 10 is an illustration of a scenario 1000 involving an example non-transitory machine readable medium 1002. The non-transitory machine readable medium 1002 may comprise processor-executable instructions 1012 that when executed by a processor 1016 cause performance (e.g., by the processor 1016) of at least some of the provisions herein. The non-transitory machine readable medium 1002 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 1002 stores computer-readable data 1004 that, when subjected to reading 1006 by a reader 1010 of a device 1008 (e.g., a read head of a hard disk drive, or a read operation invoked on a solid-state storage device), express the processor-executable instructions 1012. In some embodiments, the processor-executable instructions 1012, when executed cause performance of operations, such as at least some of the example method 200 of FIG. 2 and/or at least some of the example method 600 of FIG. 6, for example. In some embodiments, the processor-executable instructions 1012 are configured to cause implementation of a system, such as at least some of the example system 300 of FIGS. 3A-3C, at least some of the example system 400 of FIG. 4, and/or at least some of the example system 500 of FIG. 5.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed:

1. A method, comprising:
detecting a device attempting to connect to a universal serial bus port of a host device;
performing a test to determine a device type of the device;
loading, by the host device, a driver for communicating with the device based upon the driver corresponding to the device type; and
performing, by the driver, a universal serial bus authentication by:
obtaining a key associated with the device;
attempting to authenticate the key using an authentication mechanism;
in response to successfully authenticating the key, retaining the universal serial bus port in an enabled state for allowing the device to communicate through the universal serial bus port with the host device; and
in response to not successfully authenticating the key, blocking the device from communication through the universal serial bus port with the host device.

2. The method of claim 1, wherein obtaining the key comprises:
receiving the key from the device through the universal serial bus port.

3. The method of claim 1, wherein obtaining the key comprises:
retrieving the key from a remote source over a network.

4. The method of claim 1, wherein obtaining the key comprises:
retrieving the key from a distributed ledger stored across a plurality of remote data sources.

5. The method of claim 1, wherein attempting to authenticate the key comprises:
attempting to authenticate the key using a certificate authority hosted by the host device, wherein the key is derived from the certificate authority.

6. The method of claim 1, wherein the attempting to authenticate the key comprises:
key using a chain certificate hosted by the host device.

7. The method of claim 1, wherein the universal serial bus authentication considers the device to be an untrusted server and the host device to be a trusted client.

8. The method of claim 1, comprising:
in response to loading the driver, triggering the universal serial bus authentication.

9. The method of claim 1, comprising:
implementing the universal serial bus authentication through security controls executing over a universal serial bus physical layer.

10. The method of claim 1, comprising:
in response to retaining the universal serial bus port in the enabled state, facilitating a troubleshooting procedure with the device in order to troubleshoot the host device.

11. A host device comprising a processor for executing instructions for performing a bus authentication operation associated with authenticating devices for communication with the host device, wherein the host device comprises:
a bus physical layer that establishes communication channels over a bus with devices connected to the bus;
a driver that is loaded for communicating to a device that is connected to the bus, wherein the driver is selected from available drivers based upon the driver corresponding to a device type of the device; and
an operating system that performs the bus authentication operation by:
obtaining authentication information associated with the device;
attempting to authenticate the authentication information using an authentication mechanism;
in response to successfully authenticating the authentication information, allowing the device to communicate over the bus with the host device; and
in response to not successfully authenticating the authentication information, blocking the device from communication over the bus with the host device.

12. The host device of claim 11, wherein the operating system utilizes a key infrastructure as the authentication mechanism, and wherein the authentication information comprises a key.

13. The host device of claim 11, wherein the operating system utilizes transport layer security (TLS) as the authentication mechanism to determine whether a TLS certificate within the authentication information is valid.

14. The host device of claim 11, wherein the bus is associated with a universal asynchronous receiver transmitter (UART) protocol.

15. The host device of claim 11, wherein at least one of the host device or the device comprises an Internet of Things (IoT) device.

16. The host device of claim 11, wherein the bus is an internal bus within the host device.

17. The host device of claim 11, wherein at least one of the device or the host device comprises flash memory, and wherein at least one of the device or the host device comprises a system on chip (SoC).

18. A non-transitory computer-readable medium storing instructions that when executed facilitate performance of operations comprising:
detecting a device attempting to connect to a universal serial bus port of a host device;
loading, by the host device, a driver for communicating with the device based upon the driver corresponding to a device type of the device; and
performing a universal serial bus authentication by:
obtaining authentication information associated with the device;
attempting to authenticate the authentication information using an authentication mechanism;
in response to successfully authenticating the authentication information, allowing the device to communicate over the bus with the host device; and
in response to not successfully authenticating the authentication information, blocking the device from communication over the bus with the host device.

19. The non-transitory computer-readable medium of claim 18, wherein the universal serial bus authentication is performed by an operating system of the host device.

20. The non-transitory computer-readable medium of claim 18, wherein the universal serial bus authentication is performed by the driver.
